(19) United States
(12) Patent Application Publication
(10) Pub. No.: US 2003/0171973 A1
(43) Pub. Date: Sep. 11, 2003

(54) Event calendaring systems and methods

(76) Inventors: Scot D. Wilce, Morris Plains, NJ (US); Kathleen Burt, Wall, NJ (US)

Correspondence Address: BUCKLEY, MASCHOFF, TALWALKAR, & ALLISON, 5 ELM STREET, NEW CANAAN, CT, 06840, US

(21) Appl. No.: 10/379,771

(22) Filed: Mar. 5, 2003

Related U.S. Application Data
(60) Provisional application No. 60/361,760, filed on Mar. 5, 2002.

(51) Int. Cl. G06F 17/60

(52) U.S. Cl. 705/9

(57) ABSTRACT

Systems and methods are provided to manage calendar entries. Included are determination of an associated event, event rule, and event nexus, determination that an entity is associated with the event nexus, determination that a calendar entry based on the event rule, and association of the calendar entry with a calendar that is associated with the entity.

### CROSS REFERENCE TO RELATED APPLICATIONS

This application claims priority to U.S. Provisional Application Serial No. 60/361,760, filed Mar. 5, 2002 and entitled “Event Calendaring Systems and Methods”.

### FIELD

The present invention relates to electronic calendaring systems.

### BACKGROUND

Many systems for managing an electronic calendar currently exist. These systems include desktop computers, dedicated or multipurpose handheld devices, and calendaring software applications executed thereby.

A typical calendaring software application allows a user to create calendar entries and to associate the entries with a particular date and time. The software application may also present a reminder of the calendar entry to the user at a pre-specified time prior to the particular date and time. The user may dismiss the reminder or may instruct the software application to re-present the reminder at a later time.

Workgroup-enabled calendaring applications may also provide functions for managing calendar entries that are associated with more than one user. These applications may allow one user to view calendar entries associated with a second user and/or to input calendar entries into the second user's calendar. In the latter case, the one user may define an event by specifying a date and time for the event as well as attendees required at the event. The defined event is submitted to a central controller, and the central controller creates calendar entries for each required attendee and associates the entries with calendars of the respective attendees. Some systems allow the attendees to confirm or reject the calendar entries.

Existing calendaring systems place significant burdens on users. For example, these systems require a user to initially recognize that a calendar entry is needed for a particular event. The user may also be required to determine which other users should be notified of the event. Even if a user could satisfy these requirements, manual entry of all necessary calendar entries would be onerous for all but the smallest organizations. Of course, this burden may increase sharply with the size of an organization.

In view of the foregoing, a system is desired to efficiently facilitate event calendaring.

### SUMMARY

To address the foregoing, embodiments of the present invention concern a system, a method, an apparatus, a computer-readable medium storing processor-executable process steps, and means to determine an associated event, event rule and event nexus, determine an entity that is associated with the nexus, determine a calendar entry based on the event rule, and associate the calendar entry with a calendar that is associated with the entity.

Some embodiments of the present invention also provide a server to receive information representing an associated event, event rule and event nexus, to receive information representing an associated entity and entity nexus, to determine that the event nexus corresponds to the entity nexus, to determine a calendar entry based on the event rule, and to associate the calendar entry with a calendar that is associated with the entity and with a user, and a user device to present the calendar entry to the user.

In another aspect, some embodiments include an event data structure to associate an event, an event rule, and an event nexus, an entity data structure to associate an entity and an entity nexus, and an event calendar data structure to associate a calendar entry with a calendar associated with the entity, the calendar entry based on the event rule in a case that the entity nexus corresponds to the event nexus.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a view of a system architecture according to some embodiments of the present invention.

FIG. 2 is a flow diagram of process steps according to some embodiments of the present invention.

FIG. 3 is a block diagram of an internal architecture of a event calendaring server according to some embodiments to the present invention.

FIG. 4 is a block diagram of an internal architecture of a user device according to some embodiments to the present invention.

FIGS. 5A through 5D are views of associated database fields according to some embodiments of the present invention.

FIGS. 6A and 6B comprise a flow diagram of process steps according to some embodiments of the present invention.

FIG. 7 is a diagram illustrating a data flow according to some embodiments of the present invention.

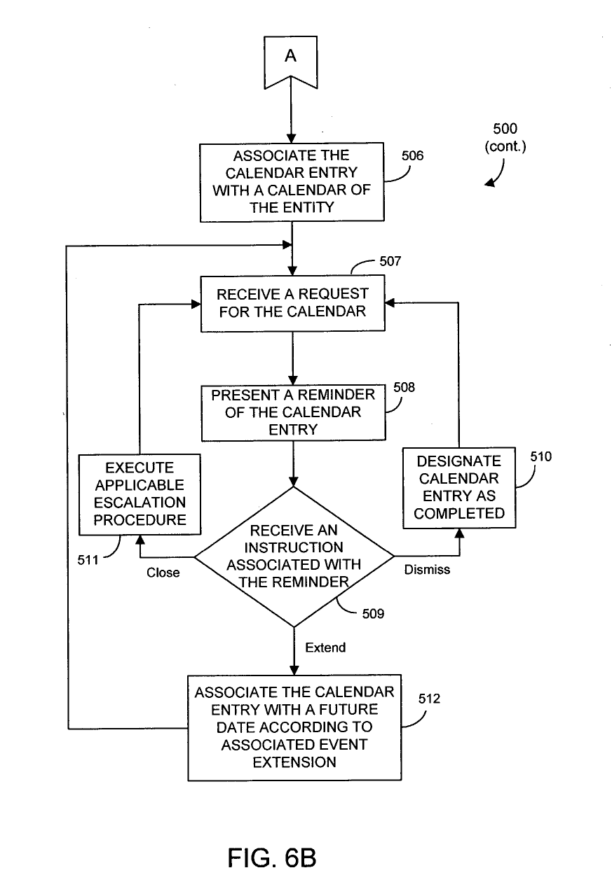

### DETAILED DESCRIPTION

System Architecture

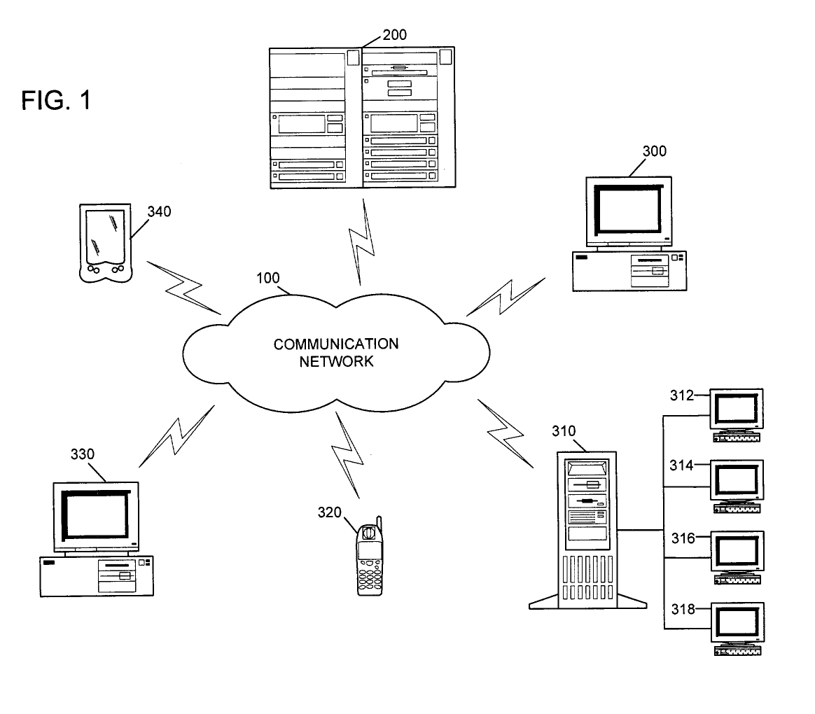

FIG. 1 illustrates an architecture of a system according to some embodiments of the present invention. As shown, communication network 100 provides communication between event calendaring server 200 and user devices 300 through 340.

Communication network 100 may comprise any number of different systems for transferring data, including a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN (e.g., in accordance with the Institute of Electrical and Electronics Engineers 802.11 standard), a Bluetooth network, an Infrared Radiation (IR) network, and/or an IP network such as the Internet, an intranet or an extranet. The physical layers utilized by these systems may include one or more of any readable medium for transferring data, including coaxial cable, twisted-pair wires, fiber-optics, RF, infrared and the like. Accordingly, communications referred to herein may include wired and/or wireless communications as appropriate.

Event calendaring server 200 is depicted as a mainframe server in FIG. 1, but may comprise any device or devices capable of performing process steps attributed to server 200 herein. As will be described below, event calendaring server 200 may provide event calendaring services for one or more organizations, with each organization being composed of several entities. Server 200 may also provide other services unrelated to event calendaring.

User devices 300, 310, 320, 330 and 340 comprise a personal computer, a network server, a cellular telephone, a personal computer and a personal digital assistant, respectively. User device 310 serves data to user terminals 312 through 318. Each user devices is capable of communicating with event calendaring server 200 over communication network 100, and of presenting a user interface to a user in operation thereof. In some embodiments, such a user interface includes an interface to present calendar entries.

The devices of FIG. 1 may be connected differently than as shown. For example, some or all of the devices may be connected directly to one another. Of course, embodiments of the invention may include devices that are different from those shown. It should also be noted that although the devices are shown in communication with each other, the devices need not be constantly exchanging data. Rather, communication may be established when necessary and severed at other times or always available but rarely used to transmit data. Moreover, although the illustrated communication links appear dedicated, it should be noted that each of the links may be shared by other devices.

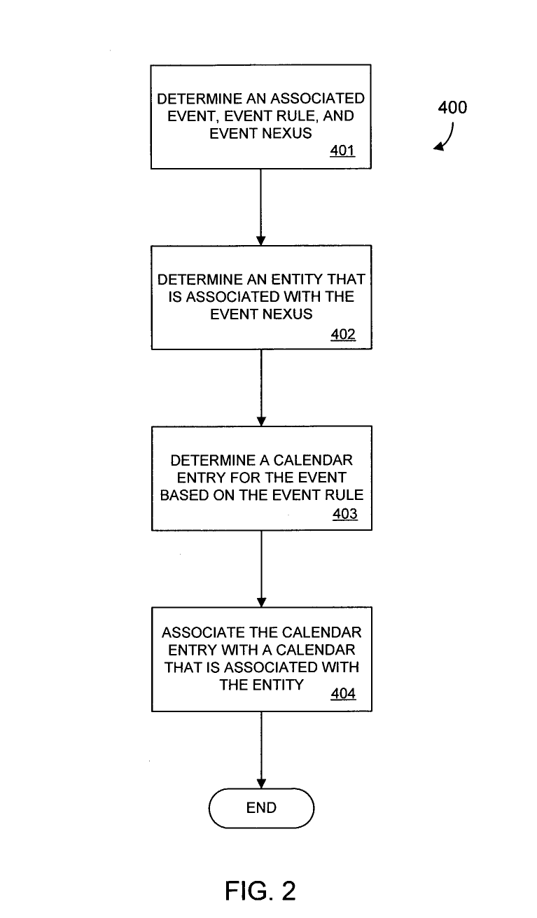

FIG. 2 is a flow diagram of process steps 400 according to some embodiments. Process steps 400 may be implemented by any combination of hardware, software or firmware. The foregoing description will assume that process steps 400 are implemented by event calendaring server 200.

Initially, an associated event, event rule and event nexus are determined. This information may be determined from an event profile stored in a memory of server 200, and/or received from an external device such as one of user devices 300 through 340. An event may consist of any thing for which an associated calendar entry may be desired. Such events may include company holidays, expiration dates, regulatory filing deadlines, deadlines for responding to inquiries, other work-related deadlines, birthdays, and anniversaries.

An event rule specifies contents of a calendar entry for the event and one or more dates and times with which the calendar entry should be associated. The event rule may include a hard-coded date (e.g., 4:00 pm, Jan. 13, 2003) or an equation based on which the dates on times may be determined. The event nexus identifies the entities for which the event is defined. The event nexus may specify a particular geographic location or any other information usable to identify specific entities.

In this regard, an entity that is associated with the event nexus is determined in step 402. The entity may be determined based on an entity profile for the entity stored in server 200 or received from another device. An entity may include, for example, a corporation, a limited liability company, a limited liability partnership, a government agency, an individual, a partnership, or other definable party or organization. An entity profile may be created in response to creation of a new legal entity, acquisition of a legal entity, expansion of a business presence into a new geo-political area, hiring a new employee, and/or new legal requirements within a jurisdiction. Details of an entity profile according to some embodiments are provided below. In the present example, the entity profile for the entity includes an entity nexus that corresponds to the event nexus determined in step 401.

Next, in step 403, a calendar entry is determined for the event based on the event rule. As described above, the contents of the entry as well as its associated dates and times may be determined from the event rule. In some embodiments, more than one calendar entry may be determined for a particular event based on one or more event rules that are associated with the event.

The determined calendar entry is associated with a calendar in step 404. The calendar may be stored in server 200, and may be associated with the entity determined in step 402. In a case that the entity is a multi-person entity, the calendar entry may be associated with calendars of any subset of persons within the entity, including a department, a workgroup, persons of similar rank, and/or a single person.

The foregoing description of FIG. 1 and FIG. 2 was intended to provide an overview of some embodiments. Further details of the above-described features are provided below along with additional features according to some embodiments.

Event Calendaring Server

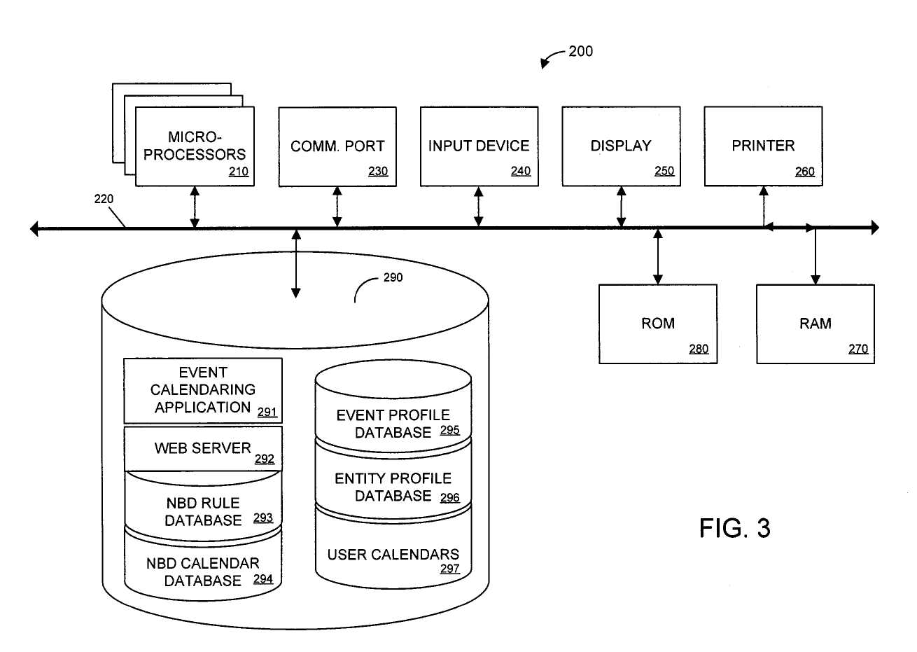

FIG. 3 is a block diagram of an internal architecture of event calendaring server 200 according to some embodiments. As illustrated, event calendaring server 200 includes microprocessors 210 in communication with communication bus 220. Microprocessors 210 may comprise RISC-based and other types of processors and are used to execute processor-executable process steps so as to control the elements of event calendaring server 200 to provide desired functionality.

Also in communication with communication bus 220 is communication port 230. Communication port 230 is used to transmit data to and to receive data from devices external to event calendaring server 200 such as devices 300 through 340. Communication port 230 is therefore preferably configured with hardware suitable to physically interface with desired external devices and/or network connections. For example, communication port 230 may comprise an Ethernet connection to a local area network through which event calendaring server 200 may receive and transmit information over the Web.

Input device 240, display 250 and printer 260 are also in communication with communication bus 220. Any known input device may comprise input device 240, including a keyboard, mouse, touch pad, voice-recognition system, or any combination of these devices. Of course, information may also be input to event calendaring server 200 from other devices via communication port 230. Display 250 may be an integral or separate CRT display, flat-panel display or the like used to display graphics and text in response to commands issued by microprocessors 210. Printer 260 may also present text and graphics to an operator, but in hardcopy form using ink-jet, thermal, dot-matrix, laser, or other printing technologies. Elements 240 through 260 are used sparingly during operation of event calendaring server 200 according to some embodiments, and are primarily used by an operator for setup and administration.

RAM 270 is connected to communication bus 220 to provide microprocessors 210 with fast data storage and retrieval. In this regard, processor-executable process steps being executed by microprocessors 210 are typically stored temporarily in RAM 270 and executed therefrom by microprocessors 210. ROM 280, in contrast, provides storage from which data can be retrieved but to which data cannot be stored. Accordingly, ROM 280 is used to store invariant process steps and other data, such as basic input/output instructions and data used during boot-up of event calendaring server 200 or to control communication port 230. It should be noted that one or both of RAM 270 and ROM 280 may communicate directly with microprocessors 210 instead of over communication bus 220.

Data storage device 290 stores, among other data, processor-executable process steps of event calendaring application 291. Microprocessors 210 therefore execute the process steps of event calendaring application 291 in order to control event calendaring server 200 to facilitate event calendaring according to some embodiments of the present invention.

The process steps of event calendaring application 291 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

Process steps of Web server 292 are also stored in data storage device 290. These process steps may be executed by microprocessors 210 to transmit data to and to receive data from Web clients, such as Web browsers, over the Web. The data may include entity profiles, event profiles, calendar entries, and calendar instructions.

Non-business day rule database 293 of data storage device 290 includes rules associated with non-business days. The rules may be grouped according to geographical location. For example, a rule associated with the United States may identify July 4^{th} as a non-business day, while a corresponding rule may not be associated with Canada.

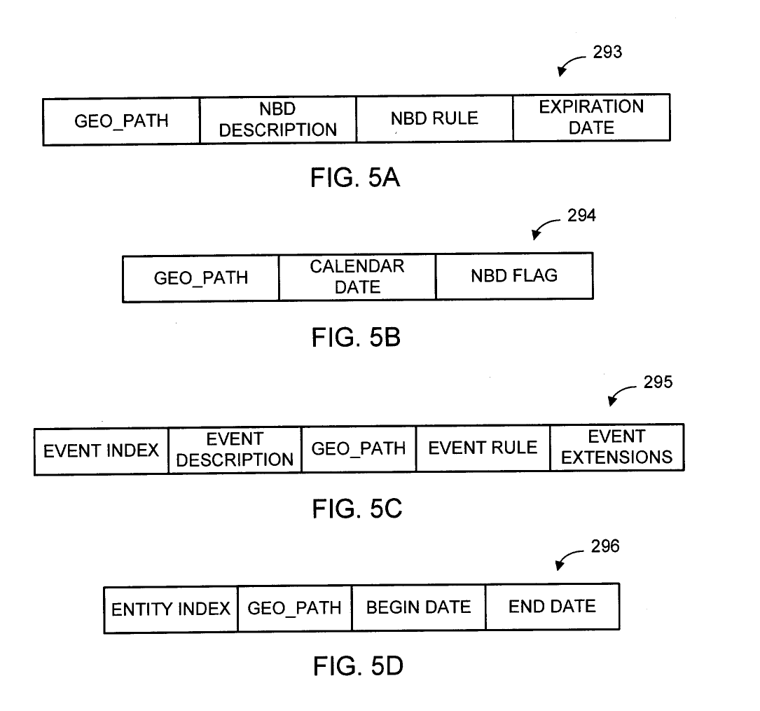

Database 293 may be used by event calendaring application 291 to determine a date with which a calendar entry should be associated. For example, an event rule may indicate that a tax filing is due on April 15^{th} of each year, unless April 15^{th} falls on a nonbusiness day. In order to generate a calendar entry based on the event rule, non-business day rule database 293 is used to determine whether April 15^{th} falls on a non-business day. A detailed example of non-business day rule database will be described below with respect to FIG. 5A.

Non-business day calendar database 294 also provides an indication of whether a specific date is a non-business day. In some embodiments, database 294 associates each day of a calendar period with a flag indicating whether the day is a non-business day. FIG. 5B shows an implementation of non-business day calendar database according to some embodiments.

Data storage device 290 also stores event profile database 295. As described above, event profile database 295 may include event rules that indicate how events should be calendared as well as event nexuses that indicate entities to which the event rules apply. Similarly, entity profile database 296 may include information descriptive of entities, including entity nexuses for determining events that correspond to the entities.

Data storage device 290 may also store user calendars 297. User calendars 297 comprise calendars associated with individual users, departments, companies, or any other entity with which a calendar may be associated. Each calendar is associated with calendar entries that may be manually associated therewith by a user operating a calendaring application. The calendar entries may also be associated with the calendars according to some embodiments of the present invention.

Also stored in data storage device 290 may also be other unshown elements that may be necessary for operation of event calendaring server 200, such as an operating system, a database management system, a database “front-end”, other applications, other data files, and “device drivers” for allowing microprocessors 210 to interface with devices in communication with communication bus 220. These elements are known to those skilled in the art, and are therefore not described in detail herein.

User Device

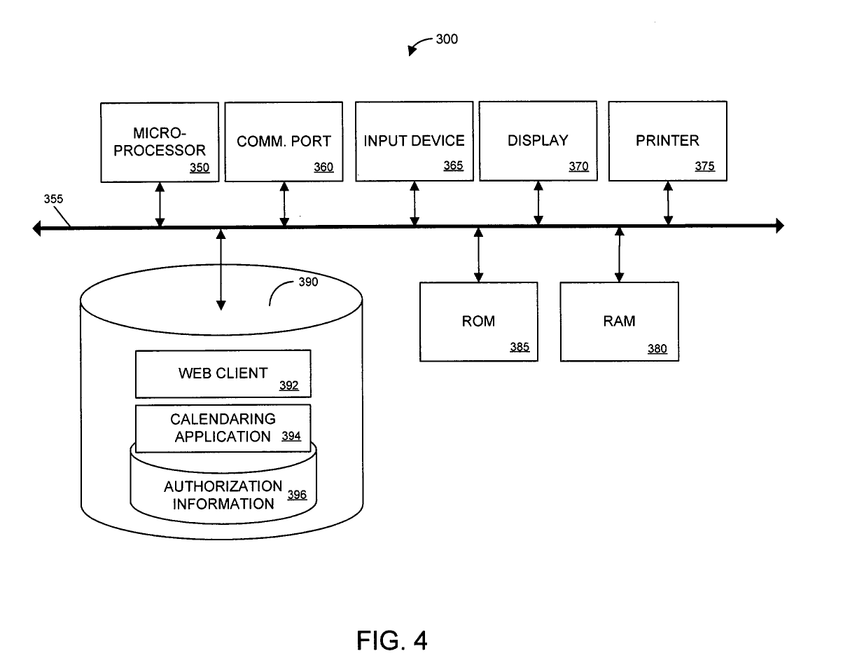

FIG. 4 illustrates several components of user device 300 according to some embodiments of the invention. It should be noted that these distinct components may comprise any of the specific examples offered with respect to identically-named components of event calendaring server 200. Of course, specific functions performed by the components may differ from the functions performed by the identically-named components.

For example, communication port 360 may be used to transmit requests for calendar entries to event calendaring server 200. In this regard, input device 365 may be used to execute a calendaring application such that a calendar associated with the user is presented via display 370. Input device 365 may also be used to input instructions to manipulate calendar entries associated with the presented calendar. Input device 365 and display 370 may also be used in conjunction with other applications provided by user device 300 which are unrelated to the present invention.

Storage device 390 of user device 300 stores processor-executable process steps of Web client 392, such as a Web browser. The process steps may be executed by microprocessor 310 to allow communication with Web servers such as Web server 292 of event calendaring server 200. Such communication may allow a user of user device 300 to add or update entity profiles, event profiles, and/or non-business day information stored in event calendaring server 200 via interactive Web pages.

Calendaring application 394 may be executed by microprocessor 310 to view and manipulate calendar entries stored in data storage device 390 or elsewhere, including among user calendars 297 of event calendaring server 200. Authorization information 396 includes information identifying a user or users operating user device 300. The information may be transmitted to event calendaring server 200 using Web client 392 or calendaring application 394 so that event calendaring server 200 may identify an associated calendar from user calendars 297.

Storage device 390 may store one or more of other applications, data files, device drivers and operating system files needed to provide functions other than those directly related to the present invention. Such functions may include calendaring, e-mail access, word processing, accounting, presentation development and the like.

Databases

Sample fields of non-business day rule database 293 are shown in FIG. 5A. As shown, each record of non-business day rule database 293 according to the illustrated embodiment includes a geographic designation (geo_path), a description of the nonbusiness day to which the record pertains (e.g., Independence Day), a rule governing the date of the non-business day (e.g. July 4^{th} each year), and an expiration date of the rule. Accordingly, non-business days for a particular geographic location may be determined by locating those records of database 293 that are associated with the geographic location via the geo_path field and determining the non-business days based on the associated non-business day rules.

FIG. 5B shows sample fields of non-business day calendar database 294. Each record of database 294 includes a geographic designation, a calendar date (e.g., Dec. 14^{th}, 2003), and a flag indicating whether the calendar date is a non-business day. Non-business day calendar 294 may therefore be used to efficiently determine if a particular day is a non-business day in a particular geographic location. The values of the non-business day flag fields may be determined based on the information stored in nonbusiness day rule database 293.

Fields of eyent profile database 295 according to some embodiments are illustrated in FIG. 5C. The fields include an event index for identifying a particular event, a description of the event, and a geographic indication (geo_path) that specifies the entities to which the event applies. The geographic indication is one example of an event nexus according to some embodiments. The fields of event profile database 295 also include an event rule that defines the contents of a calendar entry associated with the particular event, one or more dates and times with which the calendar entry should be associated, and one or more user calendars with which the calendar entry should be associated. The fields also specify extensions that may be applied to the event and therefore to the associated calendar entry. For example, an event such as a reporting deadline may be extendable by two weeks and such extendability may be reflected in event profile database 295. Consequently, event calendaring application 291 may determine that any calendar entry associated with the event may also be extended by two weeks.

FIG. 5D shows sample fields of entity profile database 296. As shown, each record specifies an index identifying an entity and a geographic designation associated with the entity. The geographic designation is an entity nexus according to some embodiments. Also specified are a begin date after which the entity should be considered to correspond to the geographic designation, and an end date after which the entity should not be considered to correspond to the geographic designation.

The information stored in databases 293 through 296 may be received from a variety of sources, including input device 240, any of user devices 300 through 340, a regulatory agency, a chamber of commerce, or any other device or entity. Moreover, the illustrations and accompanying descriptions of databases 293 through 296 merely represent relationships between stored information. A number of other arrangements may be employed besides those suggested, including arrangements in which some or all of the specified information is located remote from event calendaring server 200. It is further contemplated that each of the databases may include less or more associated fields other than those illustrated.

Process Flow

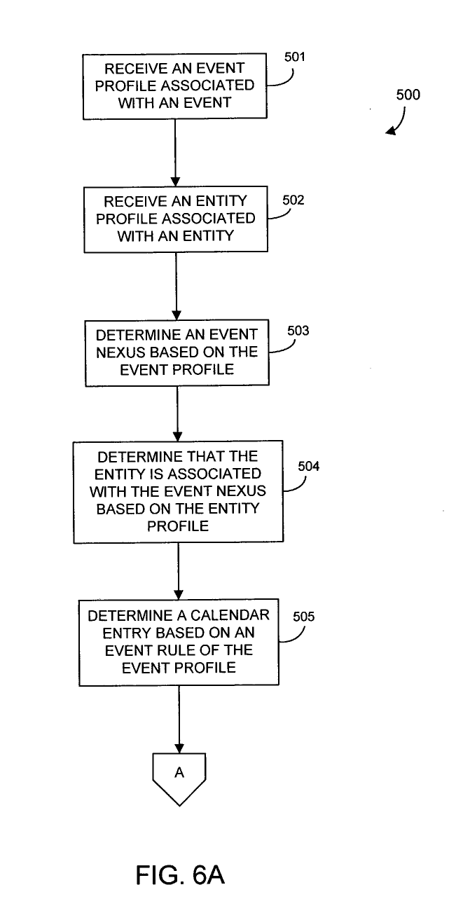

FIGS. 6A and 6B comprise a flow diagram of process steps 500 according to some embodiments. Process steps 500 are described below as if embodied in event calendaring application 291 and executed by microprocessors 210 of event calendaring server 200. However, process steps 500 may be embodied in one or more software or hardware elements and executed, in whole or in part, by any device or by any number of devices in combination, including any of user devices 300 through 340. Moreover, some or all of process steps 500 may be performed manually.

An event profile is initially received in step 501. The event profile may be received from an external device such as one of user devices 300 through 340 or from a memory of server 200. The event profile is associated with an event and may include the data fields illustrated in FIG. 5C. According to the present example, the received event profile includes an event rule and an associated event nexus. The event nexus specifies a particular geographic location of entities to which the event applies.

An entity profile is then received in step 502. The entity profile may be received from an entity at the time the entity is created, from an entity registrar, or from any other source. The received entity profile includes an entity nexus that specifies a geographic location in which the entity is located.

An event nexus is determined based on the received event profile in step 503. As mentioned above, the event nexus of the present example is a geographic location associated with the event. Step 503 may occur in response to reception of the event profile, in response to reception of the entity profile, in response to changes to an existing event profile or entity profile, and/or periodically according to a predetermined schedule.

Next, in step 504, it is determined that the entity is associated with the event nexus based on the entity profile. In one example, the determination in step 504 is based on the fact that the entity nexus of the entity profile is identical to or otherwise corresponds to the event nexus determined in step 503. In other examples, the entity profile does not include an entity nexus and the determination of step 504 is based on other data within the entity profile.

The event rule of the event profile is used in step 505 to determine a calendar entry for the entity. As described above, the contents of the entry as well as its associated dates and times may be determined from the event rule. The dates and times may also be determined based on information from non-business day rule database 293 and nonbusiness day calendar database 294. In a case that the event nexus is a geographic location, non-business days may be determined based on the event nexus and the fields of databases 293 and 294 shown in FIGS. 5A and 5B. According to some embodiments of step 505, the event rule is also used to determine the particular calendars of the entity with which the calendar entry will be associated.

Accordingly, the calendar entry is associated with a calendar of the entity in step 506. The calendar entry may be associated with more than one calendar of the entity in step 506. Association of the calendar entry with a calendar may proceed by any currently- or hereafter-known procedure for associating calendar entries with a calendar in an electronic calendaring application. After step 506, the calendar and its associated calendar entries reside among the data of user calendars 297.

A request for the calendar is received from user device 300 in step 507. The request may be submitted by executing Web client 392 to present a Web interface to display 370. A user of user device 300 then inputs a Uniform Resource Locator corresponding to Web server 292 in the Web interface and, in response, Web client 392 transmits a request for a calendar Web page to event calendaring server 200. The request may include information from authorization information 396 in order to verify an identity of the user and to determine the calendar of user calendars 297 that is associated with the user.

A Web page including the requested calendar may be presented to user device 300 from server 200 in step 508. Also presented in step 508 may be a reminder of the calendar entry that was associated with the calendar in step 506. A user may then manipulate input device 365 to transmit an instruction associated with the reminder to event calendaring server 200.

Such an instruction is received in step 509. In a case the instruction is an instruction to dismiss the reminder, event calendaring application 291 marks the calendar entry as completed in step 510 and flow returns to step 507. Accordingly, no further reminders for the entry will be presented to the user.

If the instruction is an instruction to close the reminder, it is assumed that the calendar entry has not been completed. Therefore, flow proceeds to step 511 to execute any applicable escalation procedure. In this regard, an event profile may include escalation rules for handling a non-addressed calendar entry. For example, an escalation procedure associated with an event may involve i) determination that the calendar entry has not been addressed within a predetermined timeframe and ii) association of a new calendar entry with an event calendar that is associated with a second user, such as a supervisor. The new calendar entry may include details of the original calendar entry, comments added by the original user, any consequences of not appropriately responding to the calendar entry, extensions available, or any other information relating to the entry or event. Flow returns to step 507 after step 511.

Flow proceeds to step 512 if the instruction received in step 509 is an instruction to extend the calendar entry. In step 512, any extension information associated with the event is examined to determine whether the calendar entry may be extended, and, if so, the calendar entry is associated with a future date and time. Flow then returns to step 507.

The claimed invention has been described in terms of several embodiments solely for the purpose of illustration. Persons skilled in the art will recognize from this description that the claimed invention is not limited to the embodiments described, but may be practiced with modifications and alterations limited only by the spirit and scope of the appended claims.

What is claimed is:

1. A method of managing events on a calendar, comprising:
determining an associated event, event rule and event nexus;
determining an entity that is associated with the nexus;
determining a calendar entry based on the event rule; and
associating the calendar entry with a calendar that is associated with the entity.

2. A method according to claim 1, wherein the nexus is a geographic location.

3. A method according to claim 2, wherein determining the calendar entry comprises:
determining non-business days associated with the geographic location.

4. A method according to claim 1, further comprising:
receiving an instruction to extend the calendar entry.

5. A method according to claim 4, further comprising:
determining whether the calendar entry may be extended based on extension information associated with the event.

6. A method according to claim 1, further comprising:
receiving an instruction to close the calendar entry.

7. A method according to claim 1, further comprising:
receiving an instruction to dismiss the calendar entry.

8. A method according to claim 1, further comprising:
determining that the calendar entry has not been addressed within an predetermined timeframe; and
transmitting a notification of the calendar entry based on an escalation procedure associated with the event.

9. A method according to claim 1, further comprising:
receiving an instruction to change the event rule; and
changing the calendar entry based on the changed event rule.

10. A method according to claim 1, wherein the step of determining the entity comprises:
determining an entity nexus associated with the entity; and
determining that the entity nexus corresponds to the event nexus.

11. An apparatus comprising:
a processor; and
a memory storing processor-executable process steps, the process steps executable by the processor to:
determine an associated event, event rule, and event nexus;
determine an entity that is associated with the event nexus;
determine a calendar entry based on the event rule; and
associate the calendar entry with a calendar that is associated with the entity.

12. An apparatus according to claim 11, wherein the nexus is a geographic location, and wherein the process steps executable by the processor to determine the calendar entry comprise process steps executable by the processor to determine non-business days associated with the geographic location.

13. An apparatus according to claim 11, the process steps further executable by the processor to:
receive an instruction to extend the calendar entry; and
determine whether the calendar entry may be extended based on extension information associated with the event.

14. An apparatus according to claim 11, the process steps further executable by the processor to:
determine that the calendar entry has not been addressed within an predetermined timeframe; and
transmit a notification of the calendar entry based on an escalation procedure associated with the event.

15. An apparatus according to claim 1, the process steps further executable by the processor to:
receive an instruction to change the event rule; and
change the calendar entry based on the changed event rule.

16. An apparatus according to claim 1, wherein determination of the entity comprises:
determination of an entity nexus associated with the entity; and
determination that the entity nexus corresponds to the event nexus.

17. A medium storing processor-executable process steps to:
determine an associated event, event rule, and event nexus;
determine an entity that is associated with the event nexus;
determine a calendar entry based on the event rule; and
associate the calendar entry with a calendar that is associated with the entity.

18. A medium according to claim 17, wherein the nexus is a geographic location, and wherein the process steps executable by the processor to determine the calendar entry comprise process steps executable by the processor to determine non-business days associated with the geographic location.

19. A medium according to claim 17, the process steps further comprising steps to:
receive an instruction to extend the calendar entry; and
determine whether the calendar entry may be extended based on extension information associated with the event.

20. A medium according to claim 17, the process steps further comprising steps to:
determine that the calendar entry has not been addressed within an predetermined timeframe; and
transmit a notification of the calendar entry based on an escalation procedure associated with the event.

21. A medium according to claim 17, the process steps further comprising steps to:
receive an instruction to change the event rule; and
change the calendar entry based on the changed event rule.

22. A medium according to claim 17, wherein determination of the entity comprises:
determination of an entity nexus associated with the entity; and
determination that the entity nexus corresponds to the event nexus.

23. A system comprising:
a server to receive information representing an associated event, event rule and event nexus, to receive information representing an associated entity and entity nexus, to determine that the event nexus corresponds to the entity nexus, to determine a calendar entry based on the event rule, and to associate the calendar entry with a calendar that is associated with the entity and with a user; and
a user device to present the calendar entry to the user.

24. A system according to claim 23, the user device operable by the user to transmit an instruction to extend the calendar entry to the server; and the server to determine whether the calendar entry may be extended based on extension information associated with the event.

25. A system according to claim 23, further comprising:
a second user device,
the server to determine that the calendar entry has not been addressed within an predetermined timeframe, and to transmit a notification of the calendar entry to the second user device based on an escalation procedure associated with the event.

26. A system according to claim 23, the server to determine that the calendar entry has not been addressed within an predetermined timeframe, and to transmit a notification of the calendar entry to the user device.

27. A system comprising:
an event data structure to associate an event, an event rule, and an event nexus;
an entity data structure to associate an entity and an entity nexus; and
an event calendar data structure to associate a calendar entry with a calendar associated with the entity, the calendar entry based on the event rule in a case that the entity nexus corresponds to the event nexus.

28. A system according to claim 27, further comprising:
a non-business day data structure to associate the entity nexus with a plurality of non-business days,
wherein the calendar entry is associated with a business day, the business day being different from each of the plurality of non-business days.
